(19) United States
(12) Patent Application Publication
(10) Pub. No.: US 2022/0367975 A1
(43) Pub. Date: Nov. 17, 2022

(54) CONFIGURING CELL PERFORMANCE USING SPECIFIC ANODE, CATHODE, AND SEPARATOR COMBINATIONS

(71) Applicant: ENEVATE CORPORATION, Irvine, CA (US)

(72) Inventors: Younes Ansari, Irvine, CA (US); Benjamin Yong Park, Mission Viejo, CA (US); Sanjaya D. Perera, Irvine, CA (US); Xuan-Dung Dang, Stevenson Ranch, CA (US); Sung Won Choi, San Diego, CA (US)

(21) Appl. No.: 17/318,268

(22) Filed: May 12, 2021

(51) Int. Cl. H01M 50/46; H01M 4/505; H01M 4/134; H01M 4/525; H01M 50/403; H01M 10/0525

(52) U.S. Cl. CPC H01M 50/461; H01M 4/505; H01M 4/134; H01M 4/525; H01M 50/403; H01M 10/0525; H01M 2004/027

(57) ABSTRACT

Systems and methods are provided for configuring cell performance using specific anode, cathode, and separator combinations. Separators with significant adhesive properties may be used in forming rechargeable cells, such as lithium-ion cells. The separator with significant adhesive properties may include an adhesive coating, applied on one or both sides of the separator, and/or adhesive material is dissolved or deposited within the separator. The separators with significant adhesive properties may also include one or more ceramic layers.

### TECHNICAL FIELD

Aspects of the present disclosure relate to energy generation and storage. More specifically, certain implementations of the present disclosure relate to methods and systems for configuring cell performance using specific anode, cathode, and separator combinations.

### BACKGROUND

Various issues may exist with conventional battery technologies. In this regard, conventional systems and methods, if any existed, for designing and producing batteries or components thereof may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for configuring cell performance using specific anode, cathode, and separator combinations, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 is a diagram of an example battery.

FIG. 2 is a flow diagram of an example lamination process for forming a silicon anode.

FIG. 3 is a flow diagram of an example direct coating process for forming a silicon anode.

FIG. 4 illustrates capacity retention for different cells with different separators during cycle life based on 2C(4.2V)/0.5C(2.75V) cycles.

FIG. 5 illustrates resistance for different cells with different separators during cycle life based on 2C(4.2V)/0.5C(2.75V) cycles.

FIG. 6 illustrates capacity retention for different cells with different separators during cycle life based on 4C(4.2V)/0.5C(3.2V) cycles.

FIG. 7 illustrates capacity retention for different cells with different separators during cycle life based on 2C(4.2V)/0.5C(2.75V) cycles.

FIG. 8 illustrates resistance for different cells with different separators during cycle life based on 2C(4.2V)/0.5C(2.75V) cycles.

FIG. 9 illustrates an example test case scenario for assessing adhesive characteristics of separators.

FIG. 10 illustrates example results based on use of a test case scenario for assessing adhesive characteristics of separators.

### DETAILED DESCRIPTION

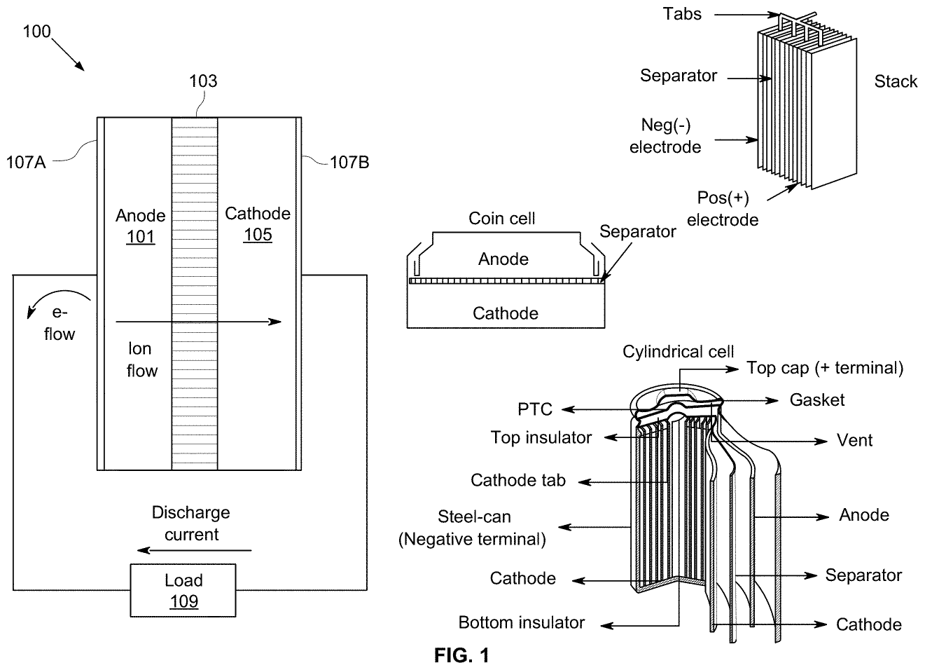

FIG. 1 is a diagram of an example battery. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1 is a very simplified example merely to show the principle of operation of a lithium ion cell. Examples of realistic structures are shown to the right in FIG. 1, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

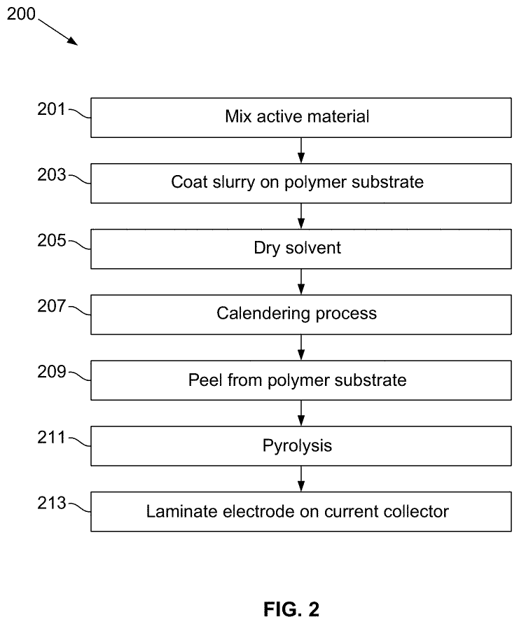

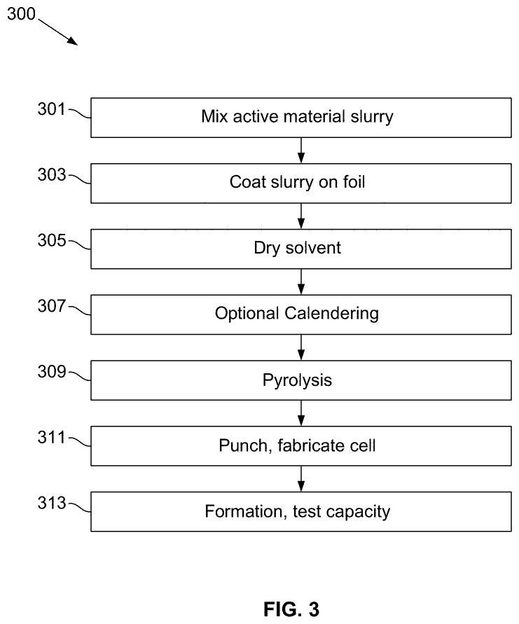

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-dominant anodes. For example, lamination or direct coating may be used in forming a silicon anode. Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 2.0 molar (M) and lithium bis(trifluoromethanesulfonyl)imide (LiTFSI) may be present at a concentration of about 0 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70% by weight.

The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (Super P), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). Graphenes and carbon nanotubes may be used because they may show similar benefits. Thus, in some instances, a mixture of two or more of carbon black, vapor grown carbon fibers, graphene, and carbon nanotubes may be used as such mixtures or combinations may be especially beneficial.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

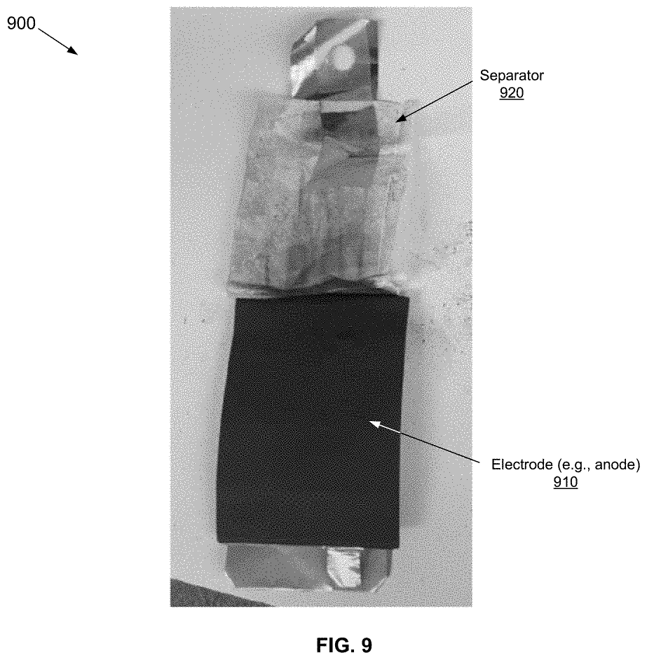

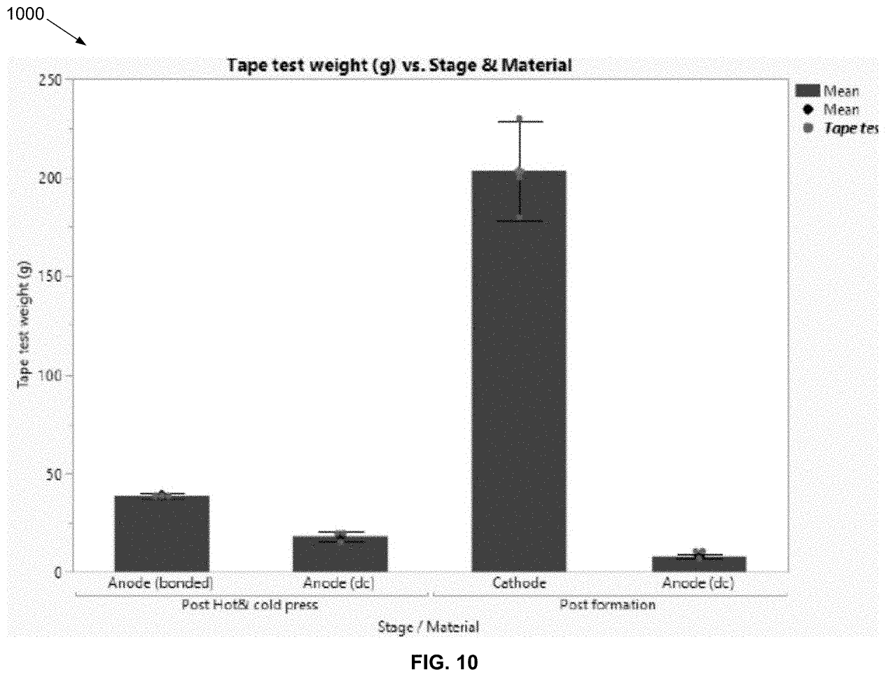

In accordance with the present disclosure, separators incorporating measures for enhancing performance of the cell may be used. In particular, in various implementations separators with significant adhesive properties may be used. In this regard, as used herein “significant adhesive properties” means “having adhesive material added or applied thereto, to increase adhesive characteristics thereof beyond any adhesive attributes otherwise present”. As used “separator with significant adhesive properties” means “having adhesive material added or applied thereto, such as on surfaces thereof, to increase adhesive characteristics thereof beyond any adhesive attributes otherwise present in the separator, such as from other components included therein (e.g., ceramic layer or coating)”. The exact improvement (or range thereof) may be determined based on testing. Example testing is described in more detail with respect to FIGS. 9 and 10, below.

In this regard, separators with an adhesive layer coating, such as Poly(methyl methacrylate) (PMMA), Poly(vinyl alcohol) (PVA), Poly(acrylic acid) (PAA), Poly(vinylidene difluoride) (PVDF), Poly(vinylidene difluoride-hexafluoropropylene) (PVDF-HFP), their derivatives and/or other polymers that absorb electrolyte may be plasticized when in contact with the electrolyte, and as a result may provide a good adhesion to electrodes (particularly anodes), especially if there is a heat treatment and pressure applied to the cell to bond the layers of the cell together (e.g., during hot and cold press). The improved adhesion may be due to the fact that plasticized polymer layer on the separator has reduced melting point. Further, the reaction between the electrolyte and the adhesive layer may provide functional groups on the separator that may reduce the interfacial resistance between the separator and the silicon-dominant anode or otherwise may protect the surface of the anode from detrimental reactions.

In instances where heat treatment is used, during heat treatment of the cell the plasticized adhesive layer on top of the separator may allow for improved adhesion between the separator and the electrodes (particularly the anode). This improved adhesion may increase the stability of the interface between the separator and the silicon-dominant anode which may result in improved cell performance—e.g., improved cycle life and prevention of any significant increase in the resistance of the cell. On the other hand, separators without such adhesive layer may not adhere well to the electrodes (particularly the anode). As a result, cells with such separator may suffer from an increase in the resistance of the cell during cycling which negatively affects its cycle life. Similarly, the adhesion of the separator to the cathode side may be enhanced by the plasticized adhesive layer. Such adhesive polymer layer may penetrate the surface pores of the anode and further improve the mechanical and electrochemical interaction between electrode materials, and act as a partial binder. Such effect may occur with or without use of a hot and a cold press.

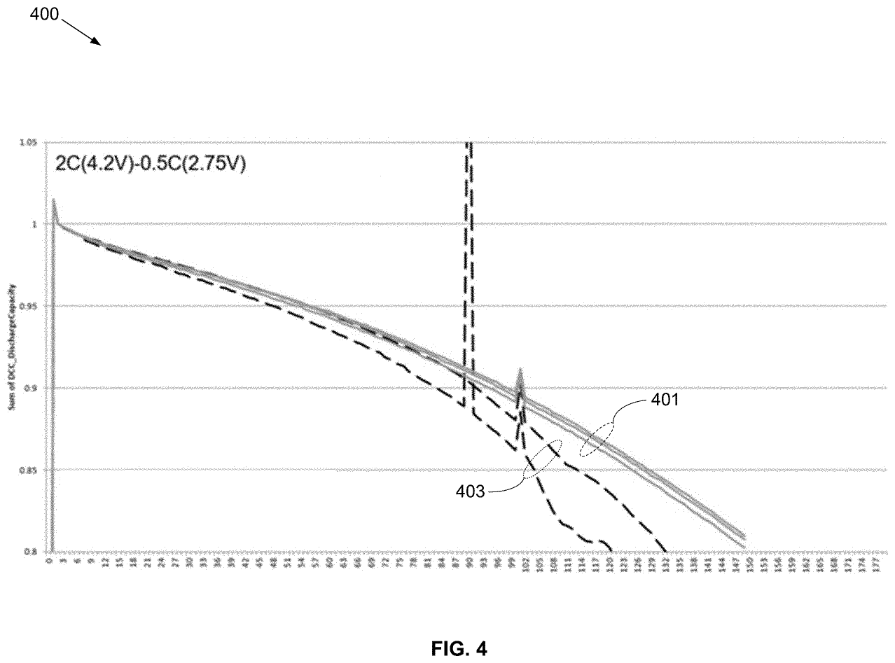

Use of separators with significant adhesive properties may have various advantages, such as increased cycle life, reduced resistance, reduced cost, reduced x-y expansion, and improved robustness and rigidity. Example use cases relating to separators with significant adhesive properties, and illustrating some of the advantages of use thereof, are shown and described in more detail with respect to FIGS. 4-8.

In an example use scenario, the effects of use of separator with significant adhesive properties may be assessed, such as by assessing effects of use of adhesive layer on the separator we tested cells with (a) a separator that has an adhesive layer containing PMMA, PVDF, and/or PVDF-HPF, and (b) a separator with a ceramic coating layer and no adhesive layer. In these cells, we used a silicon-dominant anode design such as that in accordance with the designs disclosed in U.S. patent application Ser. No. 16/896,872, filed Jun. 9, 2020, and entitled “METHOD AND SYSTEM FOR WATER SOLUBLE WEAK ACIDIC RESINS AS CARBON PRECURSORS FOR SILICON-DOMINANT ANODES”, which is incorporated herein by reference in its entirety. For example, during such tests a silicon-dominant anode with water-soluble polyamide-imide and polyimides fabricated by addition of polyacrylic acid or other polymers.

In some implementations, the adhesive layer may be applied or otherwise formed on one side or both side of the separator. In some implementations, the adhesive layer may dissolve within the separator. In some implementations, the adhesive layer may be formed or otherwise created by use of material that flow with the electrolyte, with that material then getting deposited within the separator. In some instances, use of other components, such as ceramic layers or coating, may cause under-performance.

FIG. 2 is a flow diagram of an example lamination process for forming a silicon anode. Shown in FIG. 2 is flow chart 200, comprising a plurality of example steps (represented as blocks 201-213) for an example lamination process. In this regard, this process employs a high-temperature pyrolysis process on a substrate, layer removal, and a lamination process to adhere the active material layer to a current collector.

The raw electrode active material is mixed in step 201. In the mixing process, the active material may be mixed, e.g., a binder/resin (such as PI, PAI), solvent (e.g., as organic or aqueous), and conductive additives. The materials may comprise carbon nanotubes/fibers, graphene sheets, graphene oxide, metal polymers, metals, semiconductors, and/or metal oxides, for example. The additives may comprise 1D filaments with one dimension at least 4×, at least 10×, or at least 20× that of the other two dimensions, 2D sheets or mesh with two dimensions at least 4×, at least 10×, or at least 20× that of the other dimension, or 3D structures with one dimension at least 20×, at least 10×, or at least 4×that of the other two, where none of the dimensions are of nanoscale size. Silicon powder with a 1-30 or 5-30 pm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

In step 203, the slurry may be coated on a substrate. In this step, the slurry may be coated onto a Polyester, polyethylene terephthalate (PET), or Mylar film at a loading of, e.g., 2-4 mg/cm² and then in step 205 undergo drying to an anode coupon with high Si content and less than 15% residual solvent content. This may be followed by an optional calendering process in step 207, where a series of hard pressure rollers may be used to finish the film/substrate into a smoothed and denser sheet of material.

In step 209, the green film may then be removed from the PET, where the active material may be peeled off the polymer substrate, the peeling process being optional for a polypropylene (PP) substrate, since PP can leave −2% char residue upon pyrolysis. The peeling may be followed by a pyrolysis step 211 where the material may be heated to >900° C. but less than 1250° C. for 1-3 hours, cut into sheets, and vacuum dried using a two-stage process (120° C. for 15h, 220° C. for 5 h). The dry film may be thermally treated at, e.g., 1100-1200° C. to convert the polymer matrix into carbon.

In step 212 the electrode material may be laminated on a current collector. For example, a 5-20 μm thick copper foil may be coated with polyamide-imide with a nominal loading of, e.g., 0.2-0.6 mg/cm² (applied as a 6 wt% varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The process described above is one example process that represents a composite with fabrication steps including pyrolysis and lamination. Another example scenario comprises a direct coating process in which an anode slurry is directly coated on a copper foil using a binder such as CMC, SBR, Sodium Alginate, PAI, PI, PAA, and mixtures and combinations thereof. The process in this example comprises: direct coat active material on a current collector, dry, calendering, heat treatment.

In a direct coating process, an anode slurry is coated on a current collector with residual solvent followed by a calendaring process for densification followed by pyrolysis (−500-800° C.) such that carbon precursors are partially or completely converted into pyrolytic carbon. Pyrolysis can be done either in roll form or after punching. If done in roll form, the punching is done after the pyrolysis process.

In another example of a direct coating process, an anode slurry may be coated on a current collector with low residual solvent followed by a calendaring process for densification followed by removal of residual solvent.

In an example scenario, the conductive structural additives, which may be added in step 201 in FIG. 2 or step 301 in FIG. 3, may comprise between 1 and 40% by weight of the anode composition, with between 50% and 99% silicon by weight. The fibrous (1D) particles may have an aspect ratio of at least 4, but may be higher than 10, higher than 20, or higher than 40, for example, and may comprise a tubular or fiber-like conductive structure with nanoscale size in two-dimensions, where carbon-based examples comprise carbon nanotubes, carbon nanofibers (CNF), and vapor grown carbon fibers (VGCP). Other fibrous structures are possible, such as metals, metal polymers, metal oxides

The 2D carbon structures may have an average dimension in the micron scale in each of the two non-nanoscale dimensions that is at least 4× that in the thickness direction, for example, and may be at least 20× larger, or at least 40× larger in the lateral directions as compared to the thickness direction. Graphene sheets are an example of conductive carbon additives, while other 2D structures are possible, such as “wire” meshes of metal or metal polymers, for example.

Furthermore, the active material may comprise 3D conductive structural additives, where the material is not limited to nanoscale in any one dimension. In a 3D additive example, one dimension of the structure may be at least 4×, at least 10×, or at least 20× that of the other two dimensions, where none of the dimensions are of nanoscale size. Examples of 3D conductive structural additives may be “chunks” of carbon, metal, metal polymer, or semiconductors.

In another example scenario, the anode active material layer fabricated with the carbon additive described above may comprise 20 to 95% silicon and in yet another example scenario may comprise 50 to 95% silicon by weight.

FIG. 3 is a flow diagram of an example direct coating process for forming a silicon anode. Shown in FIG. 3 is flow chart 300, comprising a plurality of example steps (represented as blocks 301-313) for an example direct coating process. In this regard, this process comprises physically mixing the active material, conductive additive, and binder together, and coating it directly on a current collector. This example process comprises a direct coating process in which an anode or cathode slurry is directly coated on a copper foil using a binder such as CMC, SBR, Sodium Alginate, PAI, PI, PAA, and mixtures and combinations thereof.

In step 301, the active material may be mixed, e.g., a binder/resin (such as PI, PAI), solvent , and conductive and structural additive. For example, the additives may comprise conductive materials that also provide structural continuity between cracks in the anode following multiple cycles. The materials may comprise carbon nanotubes/fibers, graphene sheets, metal polymers, metals, semiconductors, and/or metal oxides, metal/carbon nanofiber or metal/carbon nanotube composites, carbon nanowire bundles, for example. Silicon powder with a 5-30 μm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

Furthermore, cathode active materials may be mixed in step 301, where the active material may comprise lithium cobalt oxide (LCO), lithium manganese oxide (LMO), lithium iron phosphate (LFP), lithium nickel cobalt manganese oxide (NMC), lithium nickel cobalt aluminum oxide (NCA), nickel, cobalt, manganese and aluminum (NCMA), lithium nickel manganese spinel, or similar materials or combinations thereof, mixed with a binder as described above for the anode active material.

In step 303, the slurry may be coated on a copper foil. Similarly, cathode active materials may be coated on a foil material, such as aluminum, for example. The active material layer may undergo a drying in step 305 resulting in reduced residual solvent content. An optional calendering process may be utilized in step 307 where a series of hard pressure rollers may be used to finish the film/substrate into a smoother and denser sheet of material. In step 307, the foil and coating proceeds through a roll press for lamination.

In step 309, the active material may be pyrolyzed by heating to 500-1000° C. such that carbon precursors are partially or completely converted into glassy carbon. The pyrolysis step may result in an anode active material having silicon content greater than or equal to 50% by weight, where the anode has been subjected to heating at or above 400° C.

Pyrolysis can be done either in roll form or after punching in step 311. If done in roll form, the punching is done after the pyrolysis process. In instances where the current collector foil is not pre-punched/pre-perforated, the formed electrode may be perforated with a punching roller, for example. The punched electrodes may then be sandwiched with a separator and electrolyte to form a cell. In some instances, separator with significant adhesive properties, in accordance with the present disclosure, maybe utilized.

In step 313, the cell may be subjected to a formation process, comprising initial charge and discharge steps to lithiate the anode, with some residual lithium remaining, and the cell capacity may be assessed.

FIG. 4 illustrates capacity retention for different cells with different separators during cycle life based on 2C(4.2V)/0.5C(2.75V) cycles. Shown in FIG. 4 is chart 400 that illustrates discharge capacity profiles for two different cells 401 and 403.

The cells 401 and 403 may comprise substantially similar composition— that is, comprising and/or using the same anode and electrode material/mixtures, and being formed in the same manner (e.g., the same process). For example, both of the cells 401 and 403 may comprise silicon-dominant anodes and NCM cathodes. The cell(s) 401, however, may comprise a separator with significant adhesive properties whereas the cell(s) 403 may comprise a separator without significant adhesive properties.

The discharge capacity for each of cells 401 and 403 may be tested/measured under the same conditions—e.g., cycles of 2C charge to 4.2V and 0.5C discharge to 2.75V (i.e., 2C(4.2V)/0.5C(2.75V) cycles). As Illustrated in FIG. 4, the normalized capacity retention of the cell(s) 401, comprising the separator with significant adhesive properties, is improved compared to the normalized capacity retention of the cell(s) 403, comprising the separator without significant adhesive properties.

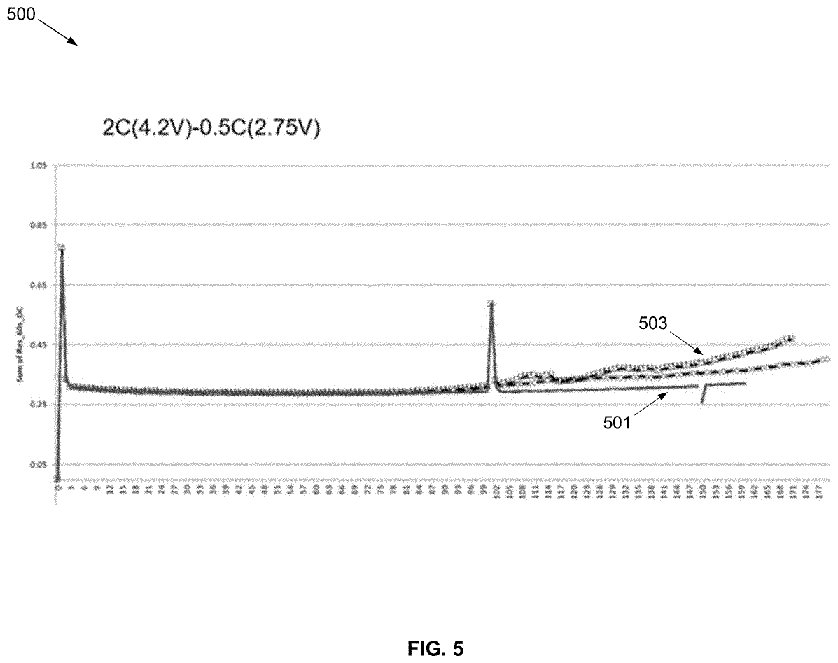

FIG. 5 illustrates resistance for different cells with different separators during cycle life based on 2C(4.2V)/0.5C(2.75V) cycles. Shown in FIG. 5 is chart 500 that illustrates resistance profiles for two different cells 501 and 503.

The cells 501 and 503 may be similar to the cells 401 and 403 of FIG. 4. In particular, the cells 501 and 503 may comprise substantially similar composition—that is, comprising and/or using the same anode and electrode material/mixtures, and being formed in the same manner (e.g., the same process). For example, both of the cells 501 and 503 may comprise silicon-dominant anodes and NCM cathodes. The cell(s) 501, however, may comprise a separator with significant adhesive properties whereas the cell(s) 503 may comprise a separator without significant adhesive properties.

The resistance of each of cells 501 and 503 may be tested/measured under the same conditions—e.g., 60-second resistance during cycles of 2C charge to 4.2V and 0.5C discharge to 2.75V (i.e., 2C(4.2V)/0.5C(2.75V) cycles). As Illustrated in FIG. 5, resistance of the cell(s) 501, comprising the separator with significant adhesive properties, is improved compared to the cell(s) 503, comprising the separator without significant adhesive properties with noticeable increase in resistance in the cell(s) 403 after a number of cycles.

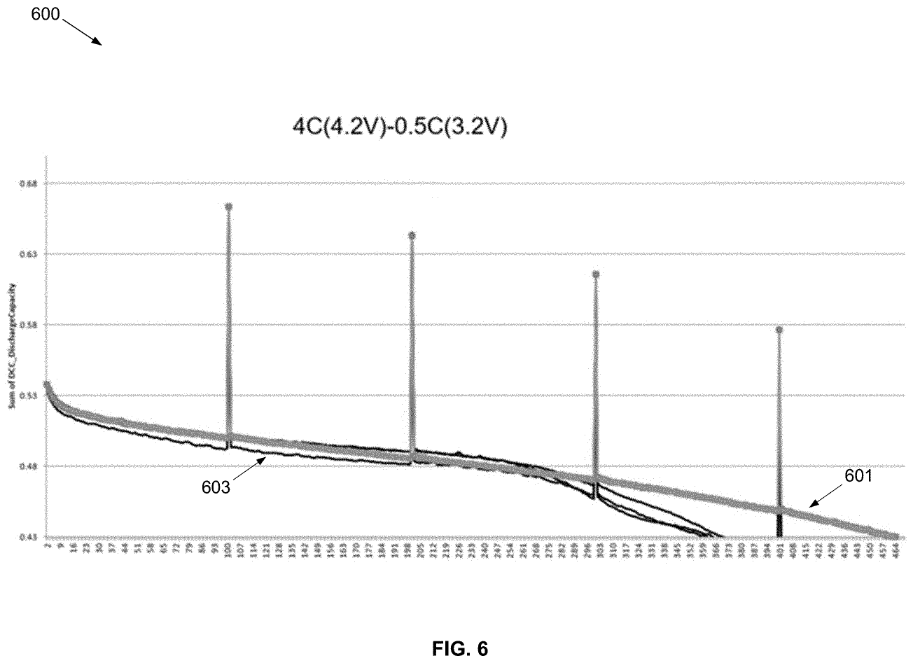

FIG. 6 illustrates capacity retention for different cells with different separators during cycle life based on 4C(4.2V)/0.5C(3.2V) cycles. Shown in FIG. 6 is chart 600 that illustrates discharge capacity profiles for two different cells 601 and 603.

The cells 601 and 603 may be similar to the cells 401 and 403 of FIG. 4. In particular, the cells 601 and 603 may comprise substantially similar composition—that is, comprising and/or using the same anode and electrode material/mixtures, and being formed in the same manner (e.g., the same process). For example, both of the cells 601 and 603 may comprise silicon-dominant anodes and NCM cathodes. The cell(s) 601, however, may comprise a separator with significant adhesive properties whereas cell(s) 603 may comprise a separator without significant adhesive properties.

The discharge capacity for each of cells 601 and 603 may be tested/measured under the same conditions—e.g., 4C charge to 4.2V and 0.5C discharge to 3.2V (i.e., 4C(4.2V)/0.5C(3.2V) cycles). As Illustrated in FIG. 6, the normalized capacity retention may be improve with use of separator with adhesive properties in similar manner as in the example test case illustrated and described with respect to FIG. 4—that is, the normalized capacity retention of the cell(s) 601, comprising the separator with significant adhesive properties, is improved compared to the normalized capacity retention of the cell(s) 603, comprising the separator without significant adhesive properties.

In some implementations, separators with significant adhesive properties in accordance with the present disclosure may be used in improving the cycling performance of silicon-dominant anodes pyrolyzed at low temperature. For example, separators with significant adhesive properties may be used in conjunction with silicon-dominant anodes based on designs as described Ser. No. 16/925111, filed on Jul. 9, 2020, and entitled “METHOD AND SYSTEM FOR WATER BASED PHENOLIC BINDERS FOR SILICON-DOMINANT ANODES”, which is incorporated herein by reference in its entirety.

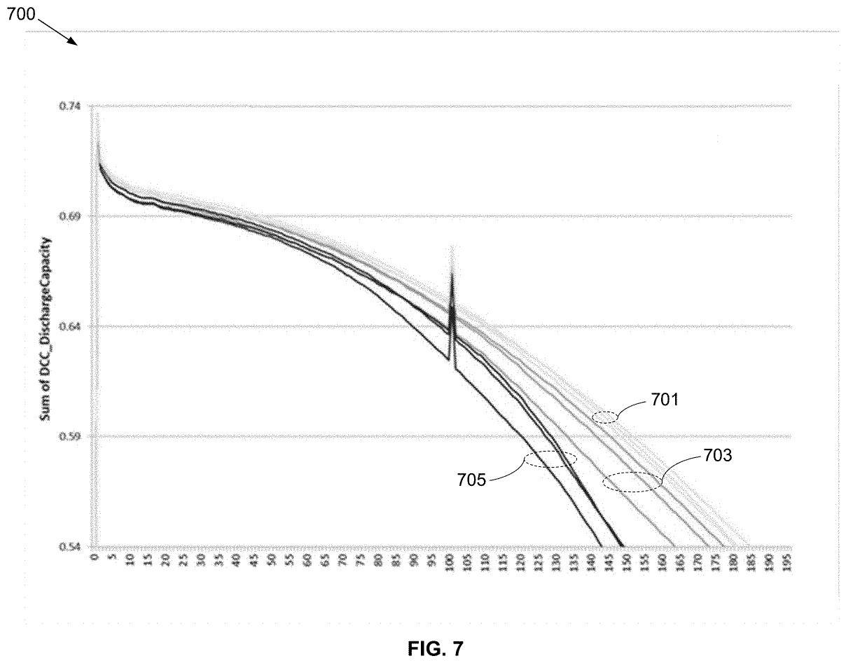

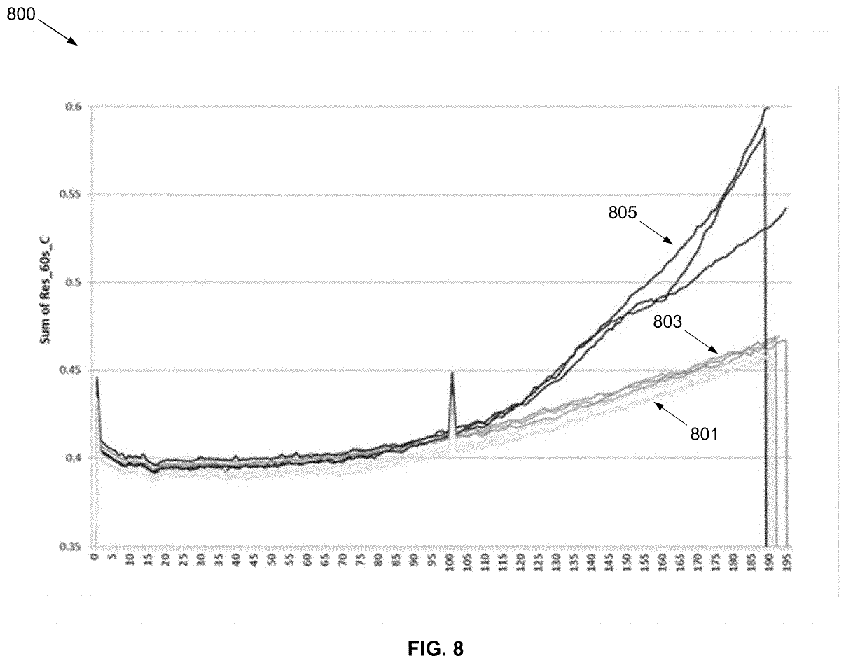

For example, in such implementations, NMP-soluble PAI polymer blend may be used as the binder. In this regard, the separators coated with PMMA/PVDF layer, and are then coated with ceramic layer and then PVDF layer as outer coating layer (e.g., the ceramic is embedded in a polymer, such as PVDF). Performance of cells incorporating such separators may be tested (e.g., with respect to cyclability and resistance), such as under 2C(4.2V)/0.5C(2.75V) test conditions, compared to cells with separator coated with ceramic layer (only) or separator with significant adhesive properties (only). Results of such tests are illustrated and described with respect to FIGS. 7 and 8.

FIG. 7 illustrates capacity retention for different cells with different separators during cycle life based on 2C(4.2V)/0.5C(2.75V) cycles. Shown in FIG. 7 is chart 400 that illustrates discharge capacity profiles for two different cells 701, 703, and 705.

The cells 701, 703, and 705 may comprise substantially similar composition—that is, comprising and/or using the same anode and electrode material/mixtures, and being formed in the same manner (e.g., the same process). For example, each of cells 701, 703, and 705 may comprise silicon-dominant anodes and NCM cathodes. These cells may, however, differ with respect to the separators used therein. In this regard, cell(s) 701 and 703 may comprise a separator with significant adhesive properties, whereas the cell(s) 705 may comprise a separator without significant adhesive properties. Additionally, the separators used in cells 703 and 705 are coated with ceramic layer.

The discharge capacity for each of cells 701, 703, and 705 may be tested/measured under the same conditions—e.g., cycles of 2C charge to 4.2V and 0.5C discharge to 2.75V (i.e., 2C(4.2V)/0.5C(2.75V) cycles). As Illustrated in FIG. 7, use of separator with significant adhesive properties yields improvement in performance, as the normalized capacity retention of the cell(s) 701 and 703, comprising separators with significant adhesive properties, is improved compared to the normalized capacity retention of the cell(s) 705, comprising the separator with ceramic coating only—i.e., without significant adhesive properties. Further, use of ceramic layer does not appear to improve performance, and may even cause under-performance. In this regard, as shown in chart 700, cyclability at 80% retention may be improved by about 20% for cell(s) 701 and by about 12% for cell(s) 703 compared to cell 705 the separator with ceramic coating only.

FIG. 8 illustrates resistance for different cells with different separators during cycle life based on 2C(4.2V)/0.5C(2.75V) cycles. Shown in FIG. 8 is chart 800 that illustrates resistance profiles for two different cells 801, 803, and 805.

The cells 801, 803, and 805 may be similar to the cells 701, 703 and 705 of FIG. 7. In particular, cells 801, 803, and 805 may comprise substantially similar composition—that is, comprising and/or using the same anode and electrode material/mixtures, and being formed in the same manner (e.g., the same process). For example, each of cells 801, 803, and 805 may comprise silicon-dominant anodes and NCM cathodes. These cells may, however, differ with respect to the separators used therein. In this regard, cell(s) 801 and 803 may comprise a separator with significant adhesive properties, whereas the cell(s) 805 may comprise a separator without significant adhesive properties. Additionally, the separators used in cells 803 and 805 are coated with ceramic layer.

The resistance cells 801, 803, and 805 may be tested/measured under the same conditions—e.g., 60-second resistance during cycles of 2C charge to 4.2V and 0.5C discharge to 2.75V (i.e., 2C(4.2V)/0.5C(2.75V) cycles). As Illustrated in FIG. 8, use of separator(s) with significant adhesive properties yields improvement in performance, as the resistance of the cell(s) 801 and 803, comprising separators with significant adhesive properties, is improved compared to the resistance of the cell(s) 805, comprising the separator with ceramic coating only—i.e., without significant adhesive properties. In this regard, growth of 60 s resistance during the cycle test is faster after about 100 cycles for cell 805 comprising the separator with ceramic coating only compared to cells 801 and 805 comprising separators with significant adhesive properties.

FIG. 9 illustrates an example test case scenario for assessing adhesive characteristics of separators. Shown in FIG. 9 is test case scenario 900, which may be used in assessing the adhesive characteristics of separators.

As illustrated in FIG. 9, adhesive characteristics of separators may be assessed by determining the amount of force required to peel a separator 920 from an electrode 910. As illustrated in FIG. 9, this may be done by using a tape that is adhered to the separator 920, and then determining the weight required to peel the separator 920 from the anode 910. Results of an example use scenario for assessing separators with significant adhesive properties are illustrated and described with respect to FIG. 10.

FIG. 10 illustrates example results based on use of a test case scenario for assessing adhesive characteristics of separators. Shown in FIG. 10 is a chart 1000 capturing the results of an example test based on the test case scenario 900 as described with respect to FIG. 9.

The results correspond to an example test using an anode (or cathode) having dimensions of 39×53 mm, with the separator cut to the same width as the anode (or cathode), and as such also having dimensions of 39×55 mm. The tape (e.g., 3M magic tape) may have width of 19 mm. Some of the conditions may be adjusted to determine which conditions yield the best results.

For example, the testing may be done to assess adhesion between separator and anode (both bonded and continuous (DC) anode), and to assess adhesion between separator and cathode. Further, the testing may be done directly after formation of the cell, or after applying heat and pressure and then applying pressure and cooling the cell to adhere the layers. The testing may also be repeated for each particular set of conditions (e.g., repeated three times), and a standard deviation (Std.Dev) for the different test runs may be determined. In this regard, each error bar may be constructed using one standard deviation from the mean. Example results from such testing are shown in the table below (and illustrated in the chart 1000 of FIG. 10):

| | | Weight | Average | |
|---|---|---|---|---|
| Stage | Material | (g) | (g) | Std.Dev |
| Post formation | Cathode | 230 | 203.3333 | 25.16611 |
| Post formation | Cathode | 200 | | |
| Post formation | Cathode | 180 | | |
| Post formation | Anode (DC) | 6.8 | 7.64 | 0.779487 |
| Post formation | Anode (DC) | 7.78 | | |
| Post formation | Anode (DC) | 8.34 | | |
| Post hot & | Anode (DC) | 20.472 | 18.13167 | 2.72502 |
| cold press | | | | |
| Post hot & | Anode (DC) | 18.783 | | |
| cold press | | | | |
| Post hot & | Anode (DC) | 15.14 | | |
| cold press | | | | |
| Post hot & | Anode (bonded) | 40.07 | 38.65333 | 1.415003 |
| cold press | | | | |
| Post hot & | Anode (bonded) | 38.65 | | |
| cold press | | | | |
| Post hot & | Anode (bonded) | 37.24 | | |
| cold press | | | | |

As illustrated in the table and in the chart 1000, the results of the example tests demonstrate adhesion strength, when a separator with significant adhesive properties is utilized, of higher than 5 g after formation or 10 g before formation between the separator and the anode, or more than 100 g between the separator and cathode.

An example lithium-ion cell, in accordance with the present disclosure, comprises a silicon-dominated anode, a cathode, and a separator with significant adhesive properties.

In an example implementation, the separator with significant adhesive properties comprises adhesive material, the adhesive material comprising one or more of Poly(methyl methacrylate) (PMMA), Poly(vinyl alcohol) (PVA), Poly(acrylic acid) (PAA), Poly(vinylidene difluoride) (PVDF), Poly(vinylidene difluoride-hexafluoropropylene) (PVDF-HFP).

In an example implementation, the separator with significant adhesive properties comprises an adhesive coating applied on one or both sides of the separator.

In an example implementation, the separator with significant adhesive properties comprises adhesive material dissolved or deposited within the separator.

In an example implementation, at least a portion of the adhesive material is dissolved or deposited within the separator by adding adhesive material into an electrolyte that flows through the separator.

In an example implementation, the separator comprises a ceramic layer.

In an example implementation, the silicon-dominated anode comprises >70% silicon.

In an example implementation, the silicon-dominated anode comprises silicon with different particle sizes, the different particle sizes comprising nano-, sub-micro-, and micro-sized particles.

In an example implementation, the silicon-dominated anode is formed from an anode mixture that comprises silicon-dominated anode active material, and one or both of a carbon-based binder and a carbon-based additive.

In an example implementation, the cathode is formed from cathode mixture comprising cathode active material, the cathode active material comprising one or more of lithium cobalt oxide (LCO), lithium manganese oxide (LMO), lithium iron phosphate (LFP), lithium nickel cobalt manganese oxide (NMC), lithium nickel cobalt aluminum oxide (NCA), nickel, cobalt, manganese and aluminum (NCMA), and lithium nickel manganese spinel

In an example implementation, the separator with significant adhesive properties results in at least one characteristic of: adhesion strength between the separator and the anode is higher than 5 g after formation, adhesion strength between the separator and the anode is higher than 10 g before formation, and adhesion strength between the separator and the cathode is higher than 100 g.

An example method for forming lithium-ion cells, in accordance with the present disclosure, comprises mixing one or more compositions for use in forming one or more of an anode, a cathode, and a separator; and forming, using the one or more compositions, a lithium-ion cell comprising a silicon-dominated anode, a cathode, and a separator with significant adhesive properties.

In an example implementation, the separator with significant adhesive properties comprises adhesive material, the adhesive material comprising one or more of Poly(methyl methacrylate) (PMMA), Poly(vinyl alcohol) (PVA), Poly(acrylic acid) (PAA), Poly(vinylidene difluoride) (PVDF), Poly(vinylidene difluoride-hexafluoropropylene) (PVDF-HFP).

In an example implementation, the separator with significant adhesive properties comprises an adhesive coating applied on one or both sides of the separator.

In an example implementation, the separator with significant adhesive properties comprises adhesive material dissolved or deposited within the separator.

In an example implementation, the method further comprises applying the adhesive material by adding the adhesive material to an electrolyte that flows through the separator.

In an example implementation, the separator comprises a ceramic layer.

In an example implementation, forming the lithium-ion cell comprises forming the silicon-dominated anode using heat treatment, the heat treatment being conducted at <850° C.

In an example implementation, forming the lithium-ion cell comprises applying heat treatment, with the heat treatment comprising a hot and cold press.

In an example implementation, the hot and cold press comprises applying hot press at 100° C./2 min and cold press at 25° C./2 min.

In an example implementation, one or both of the hot press and the cold press are applied with ±20% variation—e.g., is, applying the hot press at 100° C./2 min±20% and/or applying the cold press at 25° C./2 min±20%.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A lithium-ion cell comprising:
a silicon-dominated anode;
a cathode; and
a separator with adhesive properties, wherein the adhesive properties are increased from an initial adhesion to a significant adhesion by application of additional adhesive material to the separator, and wherein the initial adhesion is an intrinsic adhesion of the separator before the application of the additional adhesive material.

2. The lithium-ion cell of claim 1, wherein the separator with adhesive properties comprises adhesive material, the adhesive material comprising one or more of Poly(methyl methacrylate) (PMMA), Poly(vinyl alcohol) (PVA), Poly(acrylic acid) (PAA), Poly(vinylidene difluoride) (PVDF), Poly(vinylidene difluoride-hexafluoropropylene) (PVDF-HFP), and any of their derivatives.

3. The lithium-ion cell of claim 1, wherein the separator with adhesive properties comprises an adhesive coating applied on one or both sides of the separator.

4. The lithium-ion cell of claim 1, wherein the separator with adhesive properties comprises adhesive material dissolved or deposited within the separator.

5. The lithium-ion cell of claim 4, wherein at least a portion of the adhesive material is dissolved or deposited within the separator by adding adhesive material into an electrolyte that flows through the separator.

6. The lithium-ion cell of claim 1, wherein the separator comprises a ceramic layer.

7. The lithium-ion cell of claim 1, wherein the silicon-dominated anode comprises >70% silicon by weight.

8. The lithium-ion cell of claim 1, wherein the silicon-dominated anode comprises silicon with different particle sizes, the different particle sizes comprising nano-, sub-micro-, and micro-sized particles.

9. The lithium-ion cell of claim 1, wherein the silicon-dominated anode is formed from an anode mixture that comprises silicon-dominated anode active material, and one or both of a carbon-based binder and a carbon-based additive.

10. The lithium-ion cell of claim 1, wherein the cathode is formed from cathode mixture comprising cathode active material, the cathode active material comprising one or more of lithium cobalt oxide (LCO), lithium manganese oxide (LMO), lithium iron phosphate (LFP), lithium nickel cobalt manganese oxide (NMC), lithium nickel cobalt aluminum oxide (NCA), nickel, cobalt, manganese and aluminum (NCMA), and lithium nickel manganese spinel.

11. The lithium-ion cell of claim 1, wherein the separator with adhesive properties results in at least one characteristic of: adhesion strength between the separator and the anode is higher than 5 g after formation, adhesion strength between the separator and the anode is higher than 10 g before formation, and adhesion strength between the separator and the cathode is higher than 100 g.

12. A method for forming lithium-ion cells, the method comprising:
mixing one or more compositions for use in forming one or more of an anode, a cathode, and a separator; and
forming, using the one or more compositions, a lithium-ion cell comprising a silicon-dominated anode, a cathode, and a separator with adhesive properties,
wherein forming the separator with adhesive properties further comprises adding or applying additional adhesive material to the separator,
wherein the adhesive properties are increased from an initial adhesion to a significant adhesion by the adding or applying of the additional adhesive material to the separator, and
wherein the initial adhesion is an intrinsic adhesion of the separator before the application of the additional adhesive material.

13. The method of claim 12, wherein the separator with adhesive properties comprises adhesive material, the adhesive material comprising one or more of Poly(methyl methacrylate) (PMMA), Poly(vinyl alcohol) (PVA), Poly(acrylic acid) (PAA), Poly(vinylidene difluoride) (PVDF), Poly(vinylidene difluoride-hexafluoropropylene) (PVDF-HFP), and any of their derivatives.

14. The method of claim 12, wherein the separator with adhesive properties comprises an adhesive coating applied on one or both sides of the separator.

15. The method of claim 12, wherein the separator with adhesive properties comprises adhesive material dissolved or deposited within the separator.

16. The method of claim 15, further comprising applying the adhesive material by adding the adhesive material to an electrolyte that flows through the separator.

17. The method of claim 12, wherein the separator comprises a ceramic layer.

18. The method of claim 12, wherein forming the lithium-ion cell comprises forming the silicon-dominated anode using heat treatment, the heat treatment being conducted at <850° C.

19. The method of claim 12, wherein forming the lithium-ion cell comprises applying heat treatment, the heat treatment comprising a hot and cold press.

20. The method of claim 19, wherein the hot and cold press comprises applying hot press at 100° C. for 2 min and cold press at 25° C. for 2 min.

21. The method of claim 19, further comprising applying one or both of the hot and cold press with ±20% variation.
